(19) United States
(12) Patent Application Publication
(10) Pub. No.: US 2002/0097264 A1
(43) Pub. Date: Jul. 25, 2002

(54) Apparatus and methods for management of temporal parameters to provide enhanced accessibility to computer programs

(75) Inventors: Rabindranath Dutta, Austin, TX (US); Richard Scott Schwerdtfeger, Round Rock, TX (US)

Correspondence Address: Duke W. Yee, Carstens, Yee & Cahoon, LLP, P.O. Box 802334, Dallas, TX, 75380, US

(73) Assignee: IBM Corporation

(21) Appl. No.: 09/765,162

(22) Filed: Jan. 19, 2001

(51) Int. Cl. G06F 13/00

(52) U.S. Cl. 345/745; 345/744

(57) ABSTRACT

Apparatus and methods for managing temporal parameters of computer programs to enhance the accessibility of the computer programs to disabled persons are provided. The apparatus and methods provide a mechanism by which computer program data is analyzed to determine the presence of predefined temporal parameters. When the predefined temporal parameters are encountered during the analysis, the values for the temporal parameters are modified based on a user profile. The modified temporal parameters provide a different temporal output for the computer program data from that of the original computer program data. In this way, the temporal output of the computer program data is adjusted to take into consideration the cognitive disabilities of the user.

### 1. TECHNICAL FIELD

The present invention is directed to an improved network computer system. More particularly, the present invention provides apparatus and methods for management of temporal parameters to provide enhanced accessibility to computer programs.

### 2. DESCRIPTION OF RELATED ART

There has been much emphasis recently in designing computer programs such that the computer programs are more accessible to handicapped or disabled persons. Such efforts to accommodate handicapped persons have been mostly focused on the visual and aural domains. That is, the computer programs are provided with options for changing visual and audio output parameters to make the computer program interface more accessible by the handicapped person.

For example, efforts have been made to allow for enlarging the size and changing the type of fonts used by Internet browser applications and changing the color of the fonts used. In addition, web reader software applications have been devised for reading the content of a downloaded web page to a visually impaired user.

The prior art efforts have not addressed the temporal parameters of computer programs. That is, senior citizens or persons who are cognitively disabled, for example, may be able to see and hear the content of a web page but may require more time to interpret the visual and audio information from the web page. Thus, it would be beneficial to have apparatus and methods for managing temporal parameters of computer programs to provide greater accessibility to disabled persons.

### SUMMARY OF THE INVENTION

The present invention provides apparatus and methods for managing temporal parameters of computer programs to enhance the accessibility of the computer programs to disabled persons. The apparatus and methods of the present invention provide a mechanism by which computer program data is analyzed to determine the presence of predefined temporal parameters. When the predefined temporal parameters are encountered during the analysis, the values for the temporal parameters are modified based on a user profile. The modified temporal parameters provide a different temporal output for the computer program data from that of the original computer program data. In this way, the temporal output of the computer program data is adjusted to take into consideration the cognitive disabilities of the user.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram illustrating a network data processing system according to one embodiment of the present invention;

FIG. 2 is an exemplary block diagram illustrating a server device according to one embodiment of the present invention;

FIG. 3 is an exemplary block diagram illustrating a client device according to one embodiment of the present invention;

FIG. 4 is an exemplary block diagram illustrating data flow according to one embodiment of the present invention;

FIGS. 5A and 5B are diagrams illustrating an example modification of a temporal parameter of computer program data according to one embodiment of the present invention; and

FIG. 6 is a flowchart outlining an exemplary operation of one embodiment of the present invention.

### DETAILED DESCRIPTION OF THE PREFERRED EMBODIMENT

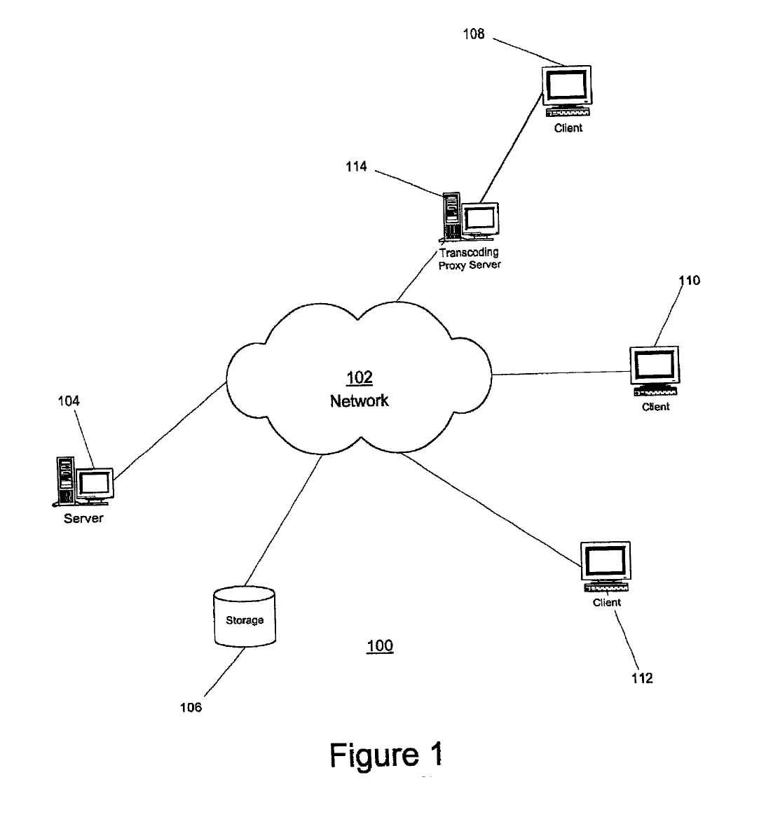

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables. In the depicted example, a server 104 is connected to network 102 along with storage unit 106. In addition, clients 108, 110, and 112 also are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown.

Transcoding proxy server 114 is a proxy for the client 108. The transcoding proxy server 114 receives requests and data from the client device 108 as well as data destined for the client device 108. The transcoding proxy server 114 may reformat data destined for the client device 108 in accordance with a user profile stored on the transcoding proxy server 114 as well as perform other processing on the received data. The other processing performed by the transcoding proxy server 114 may include processing associated with a firewall application or the like, as is generally known in the art.

In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

The present invention provides a mechanism by which temporal parameters of computer program data are identified and their values modified to accommodate a disability of a user. What is meant by “computer program data” is any input that is received which is interpreted by a computer to perform a function. For example, the computer program data may be code for generating a web document, conventional computer program code (source, executable or machine), Java bytecode, or the like. For purposes of illustration, the following exemplary embodiments of the present invention will assume that the computer program data is a HyperText Markup Language (HTML) document that is used, in a manner generally known in the art, by a web browser application to generate a web page output on a client device.

The present invention may be implemented entirely within a client device, such as client 108, or may be distributed between the client device and a server device, such as transcoding proxy server 114. If implemented entirely on the client device, the present invention may be implemented as a software application on the client device, as a part of a web browser application, as a plug-in component to a web browser application, or the like. Alternatively, the present invention may be implemented in hardware, or a combination of hardware and software, on either the client device or a server device.

In a preferred embodiment, to be described in more detail hereafter, the present invention is implemented on a transcoding proxy server. Thus, with the preferred embodiment of the present invention, a user of a client device may initiate a request for content, such as a web page document, using a web browser application resident on the client device 108. The request is received by the transcoding proxy server 114 and forwarded to an appropriate server 104 via the network 102. The appropriate server 104 may be determined, as is generally known in the art, based on header information in the data packets of the request.

The server 104 receives the request for content from the client device 108 and responds with the requested content, such as a web page document. The requested content may include one or more temporal parameters, such as a refresh rate, frame rate, animated GIF timing intervals, banner scroll rates, and the like. The requested content is transmitted by the server 104 to the client device 108 via the network 102.

The requested content is received by the transcoding proxy server 114 which then searches the requested content for predefined temporal parameters. The predefined temporal parameters are defined in a user profile stored in the transcoding proxy server 114. The user profile is retrieved when the requested content is received, based on client device address information stored in the header of the data packets of the requested content. The user profile identifies the temporal parameters for which the transcoding proxy server 114 is to search as well as the modified values for these temporal parameters.

The modified values are values that provide sufficient time, when the requested content is output, so that the user may receive the requested content and interpret the requested content. For example, the temporal parameter may be a refresh rate of a web page document banner advertisement. In such a case, if a user has diminished cognitive capacity, the refresh rate may be set to a longer time interval so that the user is provided with extra time in which to view and interpret the banner advertisement.

Based on the user profile stored on the transcoding proxy server 114, the transcoding proxy server 114 searches the requested content for the predefined temporal parameters and modifies the values for these temporal parameters as they are encountered. The values for the temporal parameters are modified to be the values set forth in the user profile. The modified requested content is then transmitted to the client device 108. In the case of a web page document, when the client device 108 receives the requested content, the web browser application on the client device receives the web page document including the modified temporal parameters, and outputs the web page document using a web browser application, in a manner generally known in the art.

Thus, the present invention provides a mechanism by which temporal parameters associated with requested content, i.e. computer program data, may be modified to accommodate disabled users. The present invention may be implemented on either a server or a client device. A server implementation is chosen as a preferred embodiment due to the ease of distributing and updating the present invention using servers rather than distributing the present invention to each individual client device. However, the distribution of the present invention to each individual client device is well within the scope of the present invention.

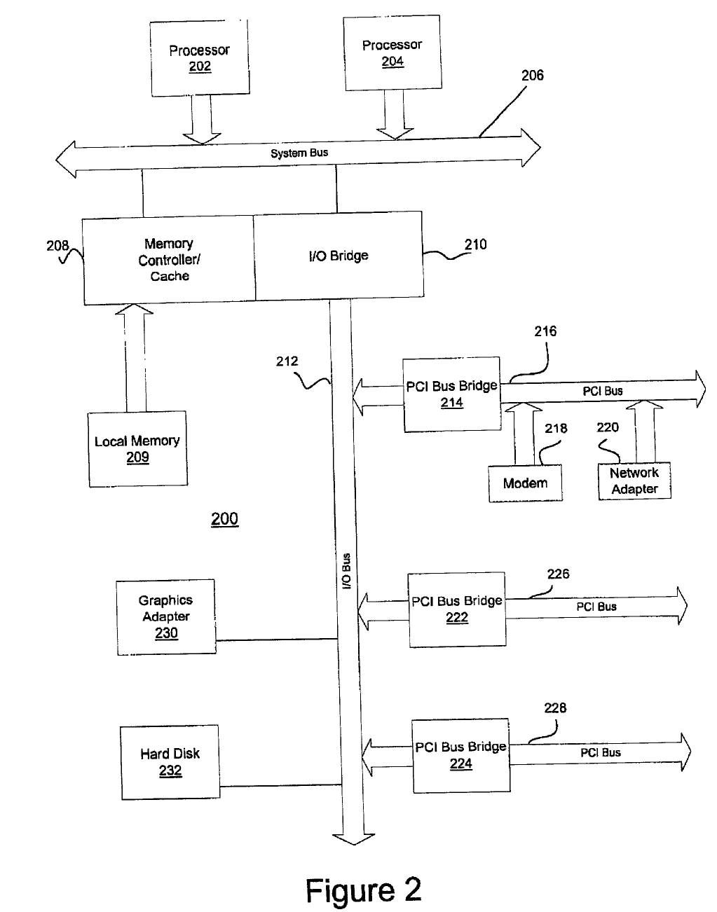

Referring to FIG. 2, a block diagram of a data processing system that may be implemented as a server, such as server 104 or transcoding proxy server 114 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

As mentioned above, the server device depicted in FIG. 2 may be used as a transcoding proxy server, such as transcoding proxy server 114 in FIG. 1. As a transcoding proxy server, the processor 202 or 204 receives a request for content from a client device via modem 218 or network adapter 220. The processor 202, for example, performs any necessary processing on the request for content and then forwards the request to the network 102 via the network adapter 220.

The request for content is then routed through the network 102, from computing device to computing device, based on address information included in the header of data packets of the request for content. The request for content eventually arrives at the content server 104 which performs the necessary processing on the request, as is generally known in the art, and responds to the request with the requested content.

The requested content is routed back to the transcoding proxy server via the network 102 based on address information stored in headers of the data packets of the requested content. The processor 202, for example, of the transcoding proxy server receives the requested content via the network adapter 220. The processor 202 performs processing on the requested content and then forwards the requested content to the client device via one of the modem 218 or the network adapter 220.

The processing performed on the requested content includes a search for predefined temporal parameters and replacement of the values of these predefined temporal parameters. Such processing includes retrieval of a user profile from local memory 209 based on client device identification information received in the header of the request for content. The user profile defines the temporal parameters that are to be searched for in requested content for this user as well as the preferred values for these temporal parameters.

Based on the user profile, the processor 202 searches the requested content for the identified temporal parameters in the user profile and replaces the values in the requested content for these temporal parameters with the preferred values in the user profile. The modified requested content is then forwarded to the client device via one of the modem 218 or the network adapter 220. In this way, the transcoding proxy server modifies requested content to take into consideration the cognitive disabilities of the user requesting the content.

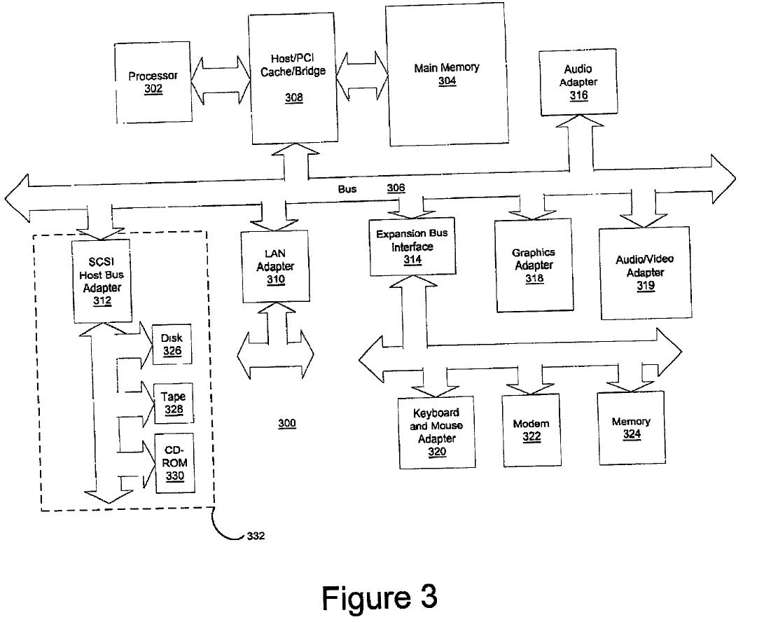

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards.

In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The client device depicted in FIG. 3 may be used to send requests for content and receive requested content using a web browser application in a manner generally known in the art. The requested content that is received may be modified by a transcoding proxy server from that sent by the content server, as described above.

Alternatively, the functions described above as being performed by the transcoding proxy server may be implemented in the client device itself. For example, the searching for temporal parameters in the requested content and replacement of the values of the identified temporal parameters may be performed by a temporal parameter adjustment application resident on the client device. The temporal parameter adjustment application may be a stand alone application, a portion of a web browser application, a plug-in application to a web browser application, or the like. With such an embodiment, the user profile described above may be stored on the client device so that it is readily retrievable by the temporal parameter adjustment application.

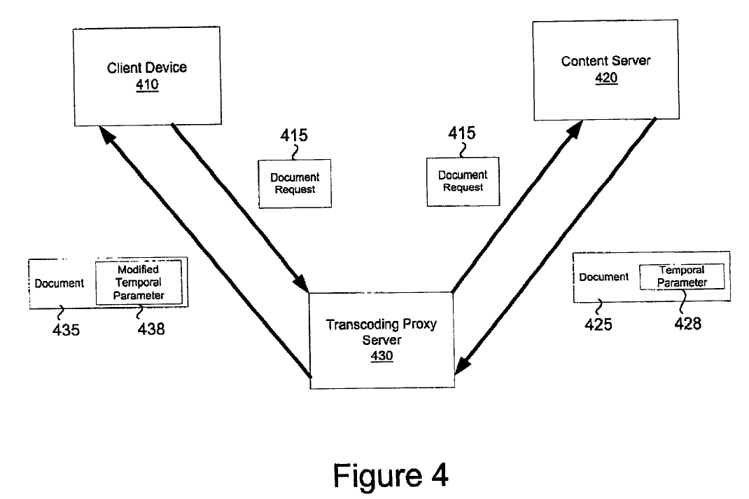

FIG. 4 provides an exemplary block diagram to illustrate the data flow between the client device, transcoding proxy server, and the content server in accordance with a preferred embodiment of the present invention. The preferred embodiment assumes, for illustration purposes, that the client device sends a request for a HyperText Markup Language (HTML) document, although the present invention is not limited to such requested content. As shown in FIG. 4, the client device 410 generates and transmits a document request 415 to the transcoding proxy server 430. The transcoding proxy server 430 performs any necessary processing on the document request 415 and forwards the request to the content server 420. The content server 420 responds to the document request by transmitting the requested document 425 to the transcoding proxy server 430. The requested document 425 sent from the content server 420 contains a temporal parameter 428.

The transcoding proxy server 430 receives the requested document 425 with the temporal parameter 428 and searches the requested document 425 for the temporal parameter 428. The transcoding proxy server 430, having found the temporal parameter 428, replaces the value for the temporal parameter 428 with a value designated in a user profile for the user of the client device 410. The resulting document 435 contains a modified temporal parameter 438. The resulting document 435 is transmitted to the client device 410. Thus, the resulting document 435 contains the same content as the document 425 transmitted by the content server 420 only with a modified temporal parameter 438.

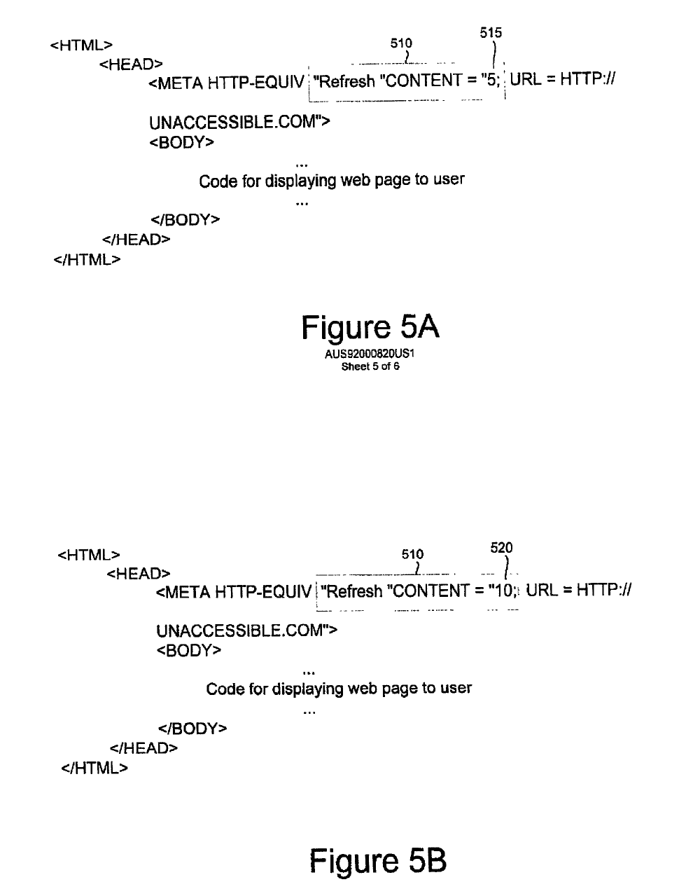

FIGS. 5A and 5B illustrate an example of the use of the present invention with a requested HTML document. FIG. 5A represents an HTML document as it is transmitted by the content server. As shown in FIG. 5A, the HTML document includes a HyperText Transfer Protocol (HTTP) refresh parameter 510 that has a value 515 set to a value of five seconds. As is generally known in the art, HTTP refresh rates are used to automatically refresh the content of a web page after a given time interval. In this way, a web page's content may be dynamically modified by a supplier of the web page or the content may be modified by referencing content from another web location.

HTTP refresh rates are typically chosen to be between one and five seconds for non-disabled users by many programmers. Thus, the five second refresh rate in the HTML document of FIG. 5A may not be sufficient for a user that suffers from a cognitive disability.

As described above, the present invention provides a mechanism by which a cognitively disabled user may have the temporal parameters of requested content modified to take into consideration the disability of the user. The resulting HTML document is shown in FIG. 5B. As shown in FIG. 5B, the value 520 for the HTTP refresh parameter 510 has been modified to ten seconds. Thus, a cognitively disabled user is provided with twice as much time between refreshes of the web page to interpret the information being displayed.

It has been stated above that the user profile includes a preferred value for the predetermined temporal parameters. The preferred value may be the actual value to which the temporal parameter should be set. Alternatively, the preferred value may be a multiplier for multiplying the original value for the temporal parameter. For example, the preferred value in the examples shown in FIGS. 5A and 5B may be the actual value of “10” or it may be a multiplier, such as “2”. In even more complex embodiments of the present invention, mathematical functions may be provided for calculating the modified value for the temporal parameter based on the original value for the temporal parameter as well as other parameters, based on the particular implementation selected.

Other mechanisms for modifying the temporal parameter values may be used without departing from the spirit and scope of the present invention. For example, the user of the client device may register with a transcoding proxy server, or with the client device, to thereby establish a user profile on the transcoding proxy server. During the process of registering, the user may provide information identifying the user's disability. The user profile may include only an indicator of the user's disability rather than a list of the temporal parameters and their associated preferred values. Based on the user's disability, the present invention may determine which temporal parameters should be searched for and their values adjusted as well as the modified values for these temporal parameters.

For example, the user may register with the transcoding proxy server and indicate that the user is 76 years old. Thus, due to the user's advanced age, the user may require additional time to interpret information provided to the user. Accordingly, the present invention may determine that the HTTP refresh time interval should be multiplied by 2, the banner scroll rate should be one half that of the original banner scroll rate, and the animated GIF timing intervals should be 7 seconds. Alternatively, the user may indicate that he/she has mild retardation. Accordingly, the present invention may determine that the HTTP refresh time interval should be multiplied by 3, the banner scroll rate should be one third that of the original banner scroll rate, and the animated GIF timing intervals should not be changed.

The determination of which temporal parameters to search for and modify, as well as the modified values for these temporal parameters, may be based on empirical data, for example. Moreover, the present invention may employ a neural network, expert system, rule-based system, or the like, to make the determination of which temporal parameters to search for and modify as well as the modified values for these temporal parameters.

The above embodiments of the present invention have been described in terms of a web browser application retrieving web page content from a content server. However, the present invention is not limited to such embodiments. Rather, the present invention may be applied to any computer program data that may include temporal parameters. The computer program data may be obtained from another computing device, such as a server, or may be resident in a local storage device, for example.

Thus, the present invention may be embodied as an application on a client device that is executed on computer program data to adjust the temporal parameters in the computer program data in view of the disability of the user. The present invention is not limited to any particular computer language and may be applied to Java code, C++, HTML, Wireless Device Markup Language (WDML), and the like.

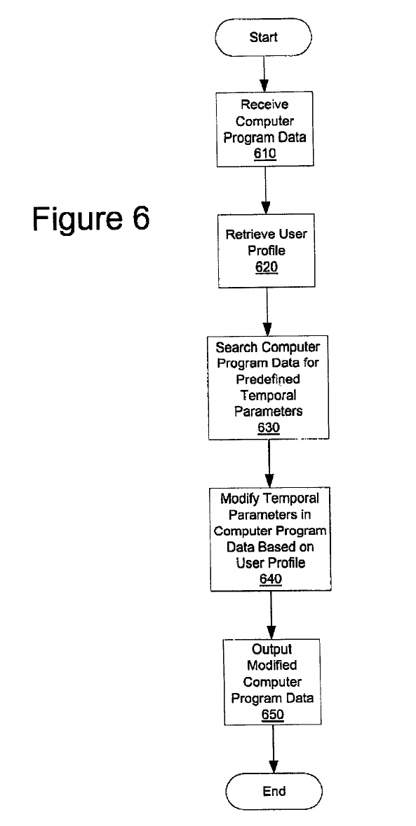

FIG. 6 is a flowchart outlining an exemplary operation of the present invention. The operation shown in FIG. 6 may be performed in a transcoding proxy server or in a client device. As shown in FIG. 6, the operation starts with receiving computer program data (step 610). The user profile is retrieved (step 620). A search of the computer program data for the predefined temporal parameters is performed (step 630). The values for the identified temporal parameters are then modified in the computer program data based on the preferred values set forth in, or calculated based on, the user profile (step 640). The modified computer program data is then output (step 650) and the operation ends.

Thus, the present invention provides a mechanism for adjusting temporal parameters in computer program data to take into consideration the disabilities of a user. In this way, a user that may have diminished cognitive capacity may be provided with additional time with which to interpret information provided to him/her by the computer program data.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of modifying computer program data, comprising:
receiving the computer program data;
searching the computer program data for a predefined temporal parameter; and
modifying the value for the predefined temporal parameter based on a user profile.

2. The method of claim 1, wherein the user profile identifies a disability of a user, and wherein modifying the value for the predefined temporal parameter based on the user profile includes modifying the value of the predefined temporal parameter based on the disability of the user.

3. The method of claim 1, wherein the user profile includes at least one of an identifier of a user disability, an identifier of the predefined temporal parameter, and a preferred value for the predefined temporal parameter.

4. The method of claim 1, wherein the user profile includes an identifier of the predefined temporal parameter, and wherein searching the computer program data for the predefined temporal parameter includes searching the computer program data based on the user profile.

5. The method of claim 1, wherein the computer program data is received from a content server.

6. The method of claim 1, wherein the computer program data is received from a proxy server.

7. The method of claim 1, wherein the computer program data is received from a storage device.

8. The method of claim 1, wherein the computer program data is a HyperText Markup Language document.

9. The method of claim 1, wherein the predefined temporal parameter is one of a HyperText Transport Protocol refresh rate, a frame rate, an animated GIF timing interval, a banner scroll rate, and a timing Interval.

10. The method of claim 1, wherein the user profile includes a preferred value for the predefined temporal parameter, and wherein modifying the value for the predefined temporal parameter based on the user profile includes setting a value of the predefined temporal parameter in the computer program data to the preferred value for the predefined temporal parameter.

11. The method of claim 1, wherein the user profile includes a multiplier for the value of the predefined temporal parameter, and wherein modifying the value for the predefined temporal parameter based on the user profile includes multiplying an original value of the predefined temporal parameter in the computer program data by the multiplier and setting a modified value of the predefined temporal parameter to the product of the multiplier and the original value of the predefined temporal parameter.

12. The method of claim 1, wherein the user profile includes an identifier of a disability of a user, and wherein modifying the value for the predefined temporal parameter based on the user profile includes:
identifying the predefined temporal parameter based on the identifier of the disability of the user; and
determining a value for the predefined temporal parameter based on the identifier of the disability of the user.

13. The method of claim 1, further comprising interpreting the computer program data to produce an output modified for use by a disabled user.

14. An apparatus for modifying computer program data, comprising:
means for receiving computer program data;
means for searching the computer program data for a predefined temporal parameter; and
means for modifying the value for the predefined temporal parameter based on a user profile.

15. The apparatus of claim 14, wherein the user profile identifies a disability of a user, and wherein the means for modifying the value for the predefined temporal parameter based on the user profile includes means for modifying the value of the predefined temporal parameter based on the disability of the user.

16. The apparatus of claim 14, wherein the user profile includes at least one of an identifier of a user disability, an identifier of the predefined temporal parameter, and a preferred value for the predefined temporal parameter.

17. The apparatus of claim 14, wherein the user profile includes an identifier of the predefined temporal parameter, and wherein the means for searching the computer program data for the predefined temporal parameter includes means for searching the computer program data based on the user profile.

18. The apparatus of claim 14, wherein the computer program data is received from a content server.

19. The apparatus of claim 14, wherein the computer program data is received from a proxy server.

20. The apparatus of claim 14, wherein the computer program data is received from a storage device.

21. The apparatus of claim 14, wherein the computer program data is a HyperText Markup Language document.

22. The apparatus of claim 14, wherein the predefined temporal parameter is one of a HyperText Transport Protocol refresh rate, a frame rate, an animated GIF timing interval, a banner scroll rate, and a timing interval.

23. The apparatus of claim 14, wherein the user profile includes a preferred value for the predefined temporal parameter, and wherein the means for modifying the value for the predefined temporal parameter based on the user profile includes means for setting a value of the predefined temporal parameter in the computer program data to the preferred value for the predefined temporal parameter.

24. The apparatus of claim 14, wherein the user profile includes a multiplier for the value of the predefined temporal parameter, and wherein the means for modifying the value for the predefined temporal parameter based on the user profile includes:
means for multiplying an original value of the predefined temporal parameter in the computer program data by the multiplier; and
means for setting a modified value of the predefined temporal parameter to the product of the multiplier and the original value of the predefined temporal parameter.

25. The apparatus of claim 14, wherein the user profile includes an identifier of a disability of a user, and wherein the means for modifying the value for the predefined temporal parameter based on the user profile includes:
means for identifying the predefined temporal parameter based on the identifier of the disability of the user; and
means for determining a value for the predefined temporal parameter based on the identifier of the disability of the user.

26. The apparatus of claim 14, further comprising means for interpreting the computer program data to produce an output modified for use by a disabled user.

27. A computer program product in a computer readable medium for modifying computer program data, comprising:
first instructions for receiving computer program data;
second instructions for searching the computer program data for a predefined temporal parameter; and
third instructions for modifying the value for the predefined temporal parameter based on a user profile.

28. The computer program product of claim 27, wherein the user profile identifies a disability of a user, and wherein the third instructions include instructions for modifying the value of the predefined temporal parameter based on the disability of the user.

29. The computer program product of claim 27, wherein the predefined temporal parameter is one of a HyperText Transport Protocol refresh rate, a frame rate, an animated GIF timing interval, a banner scroll rate, and a timing interval.

30. The computer program product of claim 27, wherein the user profile includes a preferred value for the predefined temporal parameter, and wherein the third instructions include instructions for setting a value of the predefined temporal parameter in the computer program data to the preferred value for the predefined temporal parameter.

31. The computer program product of claim 27, wherein the user profile includes a multiplier for the value of the predefined temporal parameter, and wherein the third instructions include:
instructions for multiplying an original value of the predefined temporal parameter in the computer program data by the multiplier; and
instructions for setting a modified value of the predefined temporal parameter to the product of the multiplier and the original value of the predefined temporal parameter.

32. The computer program product of claim 27, wherein the user profile includes an identifier of a disability of the user, and wherein the third instructions include:
instructions for identifying the predefined temporal parameter based on the identifier of the disability of the user; and
instructions for determining a value for the predefined temporal parameter based on the identifier of the disability of the user.

33. The computer program product of claim 27, further comprising fourth instructions for interpreting the computer program data to produce an output modified for use by a disabled user.
